(19) United States
(12) Patent Application Publication
(10) Pub. No.: US 2025/0245192 A1
(43) Pub. Date: Jul. 31, 2025

(54) DATA PROCESSING

(71) Applicant: TENCENT TECHNOLOGY (SHENZHEN) COMPANY LIMITED, Shenzhen (CN)

(72) Inventors: Chun TAO, Shenzhen (CN); Ziyang MA, Shenzhen (CN); Wentai ZHANG, Shenzhen (CN)

(73) Assignee: TENCENT TECHNOLOGY (SHENZHEN) COMPANY LIMITED, Shenzhen (CN)

(21) Appl. No.: 19/182,509

(22) Filed: Apr. 17, 2025

Related U.S. Application Data
(63) Continuation of application No. PCT/CN2024/076547, filed on Feb. 7, 2024.

(30) Foreign Application Priority Data
Mar. 22, 2023 (CN) 202310295178.2

(51) Int. Cl. G06F 16/11; G06N 3/10

(52) U.S. Cl. CPC G06F 16/116; G06N 3/10

(57) ABSTRACT

In a data processing method, an indication of a data format of input data of a neural network model is obtained. An initial model file for the neural network model is obtained, the initial model file indicating an operator of the neural network model. A data sub-format of input data of the operator is obtained by processing circuitry based on both the data format and the operator. Attribute information of the processing circuitry is obtained. A final model file for the processing circuitry is obtained based on compiling the initial model file according to both the attribute information and the data sub-format. A processing result is obtained based on running the final model file, by the processing circuitry, with data to be processed by the neural network model. Apparatus and non-transitory computer-readable storage medium counterpart embodiments are also contemplated.

### RELATED APPLICATIONS

The present application is a continuation of International Application No. PCT/CN2024/076547, filed on Feb. 7, 2024, which claims priority to Chinese Patent Application No. 202310295178.2, filed on Mar. 22, 2023. The entire disclosures of the prior applications are hereby incorporated by reference.

### FIELD OF THE TECHNOLOGY

This disclosure relates to data processing technologies, including to a data processing method and apparatus, a device, a storage medium, and a program product.

### BACKGROUND OF THE DISCLOSURE

With the development of science and technology, neural network models are increasingly widely used. Usually, a neural network model may be run by a processor to process input data of the neural network model.

Currently, when a neural network model is run by a processor, a shape of input data of the neural network model are fixed and unchangeable, that is, a shape of input data of the processor are fixed, resulting in low flexibility when the input data is processed by using the neural network model run by the processor.

### SUMMARY

Embodiments of this disclosure include a data processing method and apparatus, an electronic device, a non-transitory computer-readable storage medium, and a program product. The embodiments may be used, for example, to resolve a technical problem of low flexibility when input data is processed by using a neural network model run by processing circuitry, such as a processor.

Technical solutions of embodiments of this disclosure may be implemented as follows.

An embodiment of this disclosure provides a data processing method. In the method, an indication of a data format of input data of a neural network model is obtained. An initial model file for the neural network model is obtained, the initial model file indicating an operator of the neural network model. A data sub-format of input data of the operator is obtained by processing circuitry based on both the data format and the operator. Attribute information of the processing circuitry is obtained. A final model file for the processing circuitry is obtained based on compiling the initial model file according to both the attribute information and the data sub-format. A processing result is obtained based on running the final model file, by the processing circuitry, with data to be processed by the neural network model.

An embodiment of this disclosure provides an electronic device that includes a memory and a processor. The memory is configured to store executable instructions. The processor is configured to implement, when executing the executable instructions stored in the memory, the data processing method provided in embodiments of this disclosure.

An embodiment of this disclosure provides an apparatus for data processing. The apparatus includes processing circuitry that is configured to obtain an indication of a data format of input data of a neural network model. The processing circuitry is configured to obtain an initial model file for the neural network model, the initial model file indicating an operator of the neural network model. The processing circuitry is configured to obtain, by processing circuitry, a data sub-format of input data of the operator based on both the data format and the operator. The processing circuitry is configured to obtain attribute information of the processing circuitry. The processing circuitry is configured to obtain a final model file for the processing circuitry based on compiling the initial model file according to both the attribute information and the data sub-format. The processing circuitry configured to obtain a processing result based on running the final model file, by the processing circuitry, with data to be processed by the neural network model.

An embodiment of this disclosure provides a non-transitory computer-readable storage medium. The computer-readable storage medium stores instructions, that when executed by a processor, cause the processor to perform the data processing method provided in embodiments of this disclosure.

An embodiment of this disclosure provides a computer program product. The computer program product includes a computer program, the computer program, when executed by a processor, implementing the data processing method provided in embodiments of this disclosure.

Embodiments of this disclosure may include the following beneficial effects. The data format of the input data of the neural network model is usually fixed, and the data format may change while the processor runs the neural network model. Therefore, to improve the flexibility of running the neural network model by the processor, the data format that may change can be pre-obtained. The data format that may change is determined by the operator included in the neural network model. Therefore, in the embodiments of this disclosure, the data format of the input data of the neural network model can be obtained and the initial model file of the neural network model can be obtained, where the initial model file includes the operator of the neural network model. Then, mapping processing is performed on the data format according to the operator, to obtain the data sub-format of the input data of the operator, that is, a data format obtained after changing due to the operator. Next, attribute information of the processor is obtained, and compilation processing is performed on the initial model file according to the attribute information and the data sub-format, to obtain the final model file matching the processor so that the final model file includes the data sub-format and the final model file is a file supported by the processor. In this way, when the data format of the data to be processed of the neural network model is the data format of the input data of the neural network model, the data to be processed of the neural network model can be processed by the processor by directly running the final model file, to obtain the processing result of the data to be processed, without manually generating the final model file in the process of processing the data to be processed, thereby improving the flexibility of processing the data to be processed by using the neural network model run by the processor.

### BRIEF DESCRIPTION OF THE DRAWINGS

FIG. 1 is a schematic diagram of a scenario of a data processing process according to an embodiment of this disclosure.

FIG. 2 is a schematic flowchart of a data processing method according to an embodiment of this disclosure.

FIG. 3 is a schematic flowchart of another data processing method according to an embodiment of this disclosure.

FIG. 4 is a schematic diagram of a data sub-format and a subgraph according to an embodiment of this disclosure.

FIG. 5 is a schematic diagram of a data processing method according to an embodiment of this disclosure.

FIG. 6 is a schematic diagram of a structure of a data processing apparatus according to an embodiment of this disclosure.

FIG. 7 is a schematic diagram of a structure of an electronic device according to an embodiment of this disclosure.

### DESCRIPTION OF EMBODIMENTS

To make the objectives, technical solutions, and advantages of this disclosure clearer, the following describes this disclosure in further detail with reference to the accompanying drawings in the embodiments of this disclosure. The described embodiments are not to be considered as a limitation on this disclosure. Other embodiments are within the scope of this disclosure.

Embodiments of this disclosure provide a data processing method and apparatus, a device, a storage medium, and a program product. The device may be an electronic device, the storage medium may be a computer storage medium, and the program product may be a computer program product. The data processing apparatus may be integrated into an electronic device, and the electronic device may be a server, or may be a device such as a terminal.

The server may be an independent physical server, or may be a server cluster including a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

In addition, a plurality of servers may form a blockchain, and the server may form a node on the blockchain.

The terminal may be a smartphone, a tablet computer, a notebook computer, a desktop computer, a smart speaker, a smartwatch, or the like, but is not limited thereto. The terminal and the server may be directly or indirectly connected in a wired or wireless communication manner. This is not limited in this disclosure.

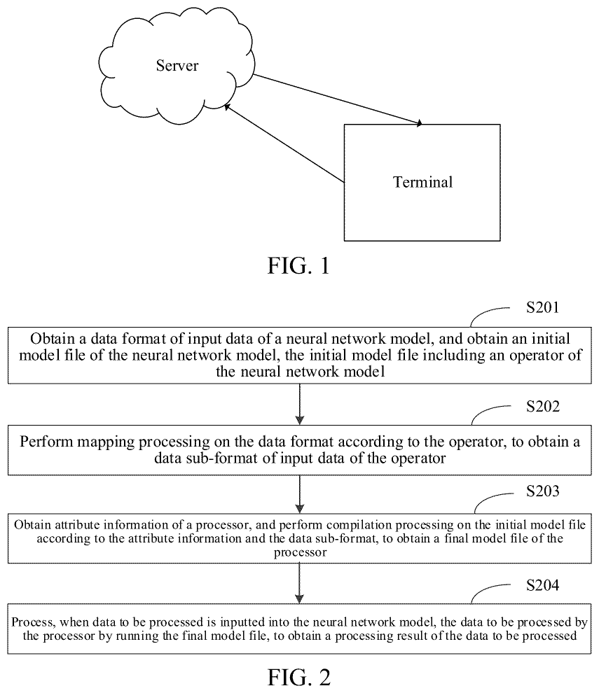

For example, as shown in FIG. 1, the server obtains a data format of input data of a neural network model, and obtains an initial model file of the neural network model, the initial model file including an operator of the neural network model; performs mapping processing on the data format according to the operator, to obtain a data sub-format of input data of the operator; and obtains attribute information of the processor, and performs compilation processing on the initial model file according to the attribute information and the data sub-format, to obtain a final model file matching the processor. The server transmits the final model file to the terminal, and the terminal processes data to be processed of the neural network model by the processor by running the final model file, to obtain a processing result of the data to be processed.

In addition, “a plurality of” in the embodiments of this disclosure refers to two or more. In the embodiments of this disclosure, “first”, “second”, and the like are configured for distinguishing descriptions, and cannot be understood as implying relative importance.

The method provided in the embodiments of this disclosure mainly involves artificial intelligence technology. For example, solutions provided in the embodiments of this disclosure involve technologies such as computer vision technology and machine learning of artificial intelligence. Details are described by using the following embodiments. The description order of the following embodiments is not intended to limit the preferred order of the embodiments.

In this embodiment, descriptions are provided from the perspective of the data processing apparatus. The data processing apparatus may be specifically integrated into a device such as a server or a terminal. For ease of description, the data processing method of this disclosure is described in detail below with the data processing apparatus integrated in the terminal, that is, with the terminal as an execution body.

FIG. 2 is a schematic flowchart of a data processing method according to an embodiment of this disclosure. The data processing method may include the following operations.

S201: Obtain a data format of input data of a neural network model, and obtain an initial model file of the neural network model, the initial model file including an operator of the neural network model. In an example, an indication of a data format of input data of a neural network model is obtained and an initial model file for the neural network model is obtained, the initial model file indicating an operator of the neural network model.

The neural network model may be a statistical learning algorithm that attempts to simulate a structure and a function of a biological neural network, and mainly includes an input layer, a hidden layer, and an output layer. The input layer is configured to receive the input data as an input of the neural network model, the hidden layer is configured to perform various processing on the input data, and the output layer is configured to output a prediction result of the neural network model according to different tasks.

The neural network model continuously performs data training to establish a mapping relationship between samples and labels through a training data set. The mapping relationship may be a linear function or a non-linear function. The function well reflects a relationship between similar samples and labels, that is, the mapping relationship, so that the neural network model can obtain, based on the input data, the prediction result having the mapping relationship with the input data.

The data format of the input data may refer to an existence form of a tensor corresponding to the input data, and may include at least one of a data type or a data shape. The data type refers to a storage format of the input data. For example, the data type may be int or float. The data shape refers to a layout manner of the input data. For example, the data shape of the input data may be (N, C, H, W) or (N, H, W, C), where N represents the number, C represents the number of channels, H represents a height, W represents a width, and (1, 3, 224, 224) and (1,3, 448, 448) represent two data shapes.

The data format of the input data may include at least one of the data type or the data shape, and a user may set the data format of the input data according to an actual requirement.

The initial model file may be a file including the neural network model, and may include the operator of the neural network model, network flow information of the neural network model, and the like.

In a possible implementation, the initial model file may include an identifier of the operator of the neural network model and a model parameter, or the initial model file may include an identifier of the operator of the neural network model, a model parameter, code for implementing the operator, and the like.

The neural network model may be an algorithmic mathematical model that imitates behavior features of an animal neural network for information processing, and may be a trained neural network model, or may be an initialized neural network model, that is, an untrained neural network model.

The type of the neural network model may be selected according to an actual situation. For example, the neural network model may be a recursive neural network model or an autocoder. This is not limited in the embodiments of this disclosure.

An operator (OP) may refer to a mapping from a function space to another function space, and may be understood as a computing unit. For example, the operator may be a convolution operator or a pooling operator.

The terminal may first obtain the data format of the input data of the neural network model, and then obtain the initial model file of the neural network model, or the terminal may first obtain the initial model file of the neural network model, and then obtain the data format of the input data of the neural network model, or the terminal may obtain the initial model file of the neural network model while obtaining the data format of the input data of the neural network model.

A manner in which the terminal obtains the data format and the initial model file may be selected according to an actual situation. This is not limited in the embodiments of this disclosure.

S202: Perform mapping processing on the data format according to the operator, to obtain a data sub-format of input data of the operator. In an example, a data sub-format of input data of the operator is obtained by processing circuitry, such as a processor, based on both the data format and the operator.

The data sub-format may be a format of the input data of the operator, or may be a format of output data of the operator. For example, if the neural network model is operator op1 →operator op2→operator op3, a data sub-format of input data of operator op3 may be a data sub-format of output data of operator op2.

Therefore, a data sub-format of the output data of the operator may also be obtained by performing mapping processing on the data format according to the operator.

In this embodiment of this disclosure, the data format may change in a process of a processor running the neural network model. These changes may be determined by the operator included in the neural network model. Therefore, to improve the flexibility of running the neural network model by the processor, the data format that may change may be pre-obtained. Therefore, a correspondence between the data format of the input data of the neural network model and the data sub-format of the input data of the operator may be established for different operators. Based on this, in this embodiment of this disclosure, the mapping processing may be a mapping from the data format of the input data of the neural network model to the data sub-format of the input data of the operator, that is, the data format of the input data in the correspondence is known, to determine the data sub-format of the input data of the operator in the correspondence.

Different correspondences are established for different operators. Therefore, when mapping processing is performed on the data format according to the operator, to obtain the data sub-format of the input data of the operator, the correspondence of the operator may be determined according to the operator, and further, mapping processing is performed on the data format, to obtain the data sub-format of the input data of the operator. That is, the data sub-format of the input data of the operator in the correspondence is determined based on the data format of the input data in the correspondence.

The neural network model includes at least one operator, and the at least one operator may sequentially process the input data of the neural network model. Therefore, for each operator, the operator also has its own input data, and the input data of each operator may be obtained based on the input data of the neural network model. The data format of the input data of the operator may be the same as or different from the data format of the input data of the neural network model. For example, the neural network model is operator op1→operator op2 →operator op3, input data of operator op1 may be the input data of the neural network model, input data of operator op2 may be a processing result obtained after operator op1 processes the input data of operator op1, and input data of operator op3 may be a processing result obtained after operator op2 processes the input data of operator op2.

The data sub-format may refer to a data format of input data (or output data) of each operator. Since the operator may be part of the neural network model, the data format of the input data (or the output data) of the operator may be referred to as a data sub-format. The data format of the input data of the neural network model may be an overall data format of the neural network model, and the data sub-format may be relative to the overall data format, and reflects stage-based changes of the data format.

In some embodiments, each operator may have a preset format mapping scheme and store a corresponding format mapping scheme, and the stored format mapping scheme may be invoked. Format mapping schemes of different operators may be the same or may be different. In some cases, format mapping schemes of operators of the same type may be the same. In this case, a format mapping scheme corresponding to each operator may be stored. Certainly, to save storage space, a format mapping scheme corresponding to each type of operators may be stored. For example, if an operator 1 and an operator 2 belong to operators of the same type, data sub-formats of input data of the operator 1 and the operator 2 are the same, and the operator 1 and an operator 3 belong to operators of different types, during storage of format mapping schemes, corresponding format mapping schemes may be respectively stored for the operator 1, the operator 2, and the operator 3, or corresponding format mapping schemes may be stored for operators of the type of the operator 1 and the operator 2, and corresponding format mapping schemes may be stored for operators of the type of the operator 3.

The format mapping scheme represents a mapping relationship between the data format of the input data and the data sub-format of the input data of the operator. In this way, when the data sub-format of the input data of the operator needs to be determined, a corresponding format mapping scheme may be invoked, to determine the data sub-format of the input data. In this case, the performing mapping processing on the data format according to the operator, to obtain a data sub-format of input data of the operator includes:
obtaining a format mapping scheme corresponding to the operator, where for example, the format mapping scheme of the operator may be invoked; and
performing mapping processing on the data format through the format mapping scheme, to obtain the data sub-format of the input data of the operator.

The format mapping scheme may exist in a form of a format mapping function, or may exist in a form of a format mapping table. This is not limited in the embodiments of this disclosure.

In this embodiment of this disclosure, a format mapping scheme corresponding to each operator is preset. The format mapping scheme may represent a rule according to which mapping is performed on each operator, to obtain the data format of the input data of the operator. Then, mapping processing is directly performed on the data format of the input data of the neural network model through the format mapping scheme, to obtain the data sub-format of the input data of the operator, so that the data sub-format of the input data of the operator can be obtained without performing another operation, thereby improving the speed of obtaining the data sub-format of the input data of the operator.

For example, if the data format is d1, the neural network model is operator op1→operator op2→operator op3, a format mapping scheme corresponding to operator op1 is s1, a format mapping scheme corresponding to operator op2 is s2, and a format mapping scheme corresponding to operator op3 is s3, mapping processing is performed on d1 through s1, to obtain a data sub-format of input data of operator op1, mapping processing is performed on d1 through s2, to obtain a data sub-format of input data of operator op2, and mapping processing is performed on d1 through s3, to obtain a data sub-format of input data of operator op3.

In some other embodiments, the process of performing mapping processing on the data format according to the operator, to obtain a data sub-format of input data of the operator may alternatively be:
selecting a startup operator from operators, and using the data format as a data sub-format of input data of the startup operator;
performing mapping processing on the data sub-format of the input data of the startup operator according to the startup operator, to obtain a data sub-format of output data of the startup operator; and
if a next operator of the startup operator exists in the operators, using the data sub-format of the output data of the startup operator as a data format, using the next operator as a startup operator, and returning to perform the operation of using the data format as a data sub-format of input data of the startup operator; or
if no next operator of the startup operator exists in the operators, determining the data sub-format of the input data of the operator according to the data sub-format of the input data of the startup operator.

The startup operator selected from the operators may be understood as the first operator in the neural network model.

The startup operator may be an operator whose execution order is the first in the neural network model. For example, if the data format is d1 and the neural network model is operator op1→operator op2→operator op3, operator op1 is a startup operator, d1 is used as a data sub-format of input data of operator op1, and mapping processing is performed on d1 according to operator op1, to obtain a data sub-format d2 of output data of operator op1. Since a next operator “operator op2” of operator op1 exists, a data sub-format d2 is used as a data sub-format of input data of operator op2, and mapping processing is performed on d2 according to operator op2, to obtain a data sub-format d3 of output data of operator op2. Since a next operator “operator op3” of operator op2 exists, a data sub-format d3 is used as a data sub-format of input data of operator op3, and mapping processing is performed on d3 according to operator op3, to obtain a data sub-format d4 of output data of operator op3. Since no next operator of operator op3 exists, computation is stopped, to obtain that the data sub-format of the input data of operator op1 is d1, the data sub-format of the input data of operator op2 is d2, and the data sub-format of the input data of operator op3 is d3.

In this embodiment of this disclosure, the data sub-format of the input data of each operator may be determined based on a connection relationship between the operators, to fully take into account a dynamic change the operation of the operator in the neural network model, thereby improving the accuracy of obtaining the data sub-format of the input data of the operator.

In this case, the process of performing mapping processing on the data sub-format of the input data of the startup operator according to the startup operator, to obtain a data sub-format of output data of the startup operator may be:
performing mapping processing on the data sub-format of the input data of the startup operator according to a first format mapping scheme corresponding to the startup operator, to obtain the data sub-format of the output data of the startup operator.

When the startup operator is the first operator of the neural network model, a first format mapping scheme corresponding to the first operator may be the same as a format mapping scheme corresponding to the first operator.

Alternatively, the process of performing mapping processing on the data sub-format of the input data of the startup operator according to the startup operator, to obtain a data sub-format of output data of the startup operator may be:
performing mapping processing on the data sub-format of the input data of the startup operator according to a model parameter of the startup operator, to obtain the data sub-format of the output data of the startup operator.

The model parameter of the startup operator may refer to a parameter that changes the data sub-format of the input data of the startup operator. For example, when the startup operator is a convolution operator, the model parameter of the startup operator may refer to a size and a sliding step size of a convolution kernel of the convolution operator.

In this embodiment of this disclosure, the startup operator is selected from the operators, and the data format is used as the data sub-format of the input data of the startup operator; mapping processing is performed on the data sub-format of the input data of the startup operator according to the startup operator, to obtain the data sub-format of the output data of the startup operator; if the next operator of the startup operator exists in the operators, the data sub-format of the output data of the startup operator is used as the data format, the next operator is used as the startup operator, and an operation of using the data format as a data sub-format of input data of the startup operator is returned to be performed; and if no next operator of the startup operator exists in the operators, the data sub-format of the input data of the operator is determined according to the data sub-format of the input data of the startup operator, to obtain the data sub-format of the input data of the next operator according to the data sub-format of the output data of the startup operator.

In some other embodiments, the process of performing mapping processing on the data format according to the operator, to obtain a data sub-format of input data of the operator may alternatively be:
selecting an operator to be processed from the operators, and determining a historical operator preceding the operator to be processed in the neural network model;
performing mapping processing on the data format according to the historical operator, to obtain a data sub-format of input data of the operator to be processed; and
determining the data sub-format of the input data of the operator according to the data sub-format of the input data of the operator to be processed.

The terminal may randomly select the operator to be processed from the operators, or the terminal may sequentially select the operator to be processed from the operators in execution orders of the operators in the neural network model.

The operator to be processed may be any operator in the neural network model. For example, the neural network model is operator op1→operator op2→operator op3. If the operator to be processed is to be randomly selected from the operators, the first operator to be processed selected from the operators may be operator op1, operator op2, or operator op3. If the operator to be processed is to be sequentially selected from the operators in the orders of the operators in the neural network model, the first operator to be processed selected from the operators is operator op1, the second operator to be processed selected from the operators is operator op2, and the third operator to be processed selected from the operators is operator op3.

The historical operator preceding the operator to be processed in the neural network model may be an operator whose execution order precedes an execution order of the operator to be processed in the neural network model. For example, the neural network model is operator op1→operator op2→operator op3, an execution order of operator op 1 precedes an execution order of operator op2, and the execution order of operator op2 precedes an execution order of operator op3. When the operator to be processed is operator op2, the historical operator is operator op1, and when the operator to be processed is operator op3, the historical operator may include at least one of operator op1 or operator op2.

If the operator to be processed is a startup operator, since there is no historical operator of the startup operator in the neural network model, after obtaining the operator to be processed, the terminal may determine whether the operator to be processed is a startup operator, and if the operator to be processed is a startup operator, use the data format as the data sub-format of the input data of the operator to be processed, or if the operator to be processed is not a startup operator, determine the historical operator preceding the operator to be processed in the neural network model.

In this embodiment of this disclosure, the operator to be processed is selected from the operators, and the historical operator preceding the operator to be processed in the neural network model is determined; and mapping processing is performed on the data format according to the historical operator, to obtain the data sub-format of the input data of the operator to be processed, and then the data sub-format of the input data of the operator to be processed is used as the data sub-format of the input data of the operator, so that the data sub-formats of the input data of the operators are obtained. Therefore, the data sub-format of the input data of the operator may be determined in any order, thereby improving the determining flexibility.

In a possible implementation, a process of performing mapping processing on the data format according to the historical operator, to obtain a data sub-format of input data of the operator to be processed may be:
determining a conversion model parameter according to a model parameter of the historical operator; and
performing mapping processing on the data format according to the conversion model parameter, to obtain the data sub-format of the input data of the operator to be processed.

The conversion model parameter may be a model parameter used for performing mapping processing on the data format, to obtain the data sub-format of the input data of the operator to be processed through estimation based on the conversion model parameter. For example, the neural network model is operator op1→operator op2→operator op3, the operator to be processed is operator op3, and the historical operators are operator op1 and operator op2. A conversion model parameter is determined according to a model parameter of operator op1 and a model parameter of operator op2, and then mapping processing is performed on the data format according to the conversion model parameter, to obtain a data sub-format of output data of operator op2. Then, the data sub-format of the output data of operator op2 is used as a data sub-format of input data of operator op3, so that there is no need to obtain a data sub-format of output data of the historical operator (operator op1) that is not adjacent to operator op3.

In this embodiment, the conversion model parameter is determined according to the model parameter of the historical operator, and then mapping processing is performed on the data format according to the conversion model parameter, to obtain the data sub-format of the input data of the operator to be processed, so that the data sub-format of the input data of the operator to be processed is computed without obtaining the data sub-format of the output data of the non-adjacent historical operator, thereby simplifying the determining manner, and improving the efficiency of determining the data sub-format of the input data of the operator to be processed.

Alternatively, a process of performing mapping processing on the data format according to the historical operator, to obtain a data sub-format of input data of the operator to be processed may be:
selecting a startup operator from historical operators, and using the data format as the data sub-format of the input data of the startup operator;
performing mapping processing on the data sub-format of the input data of the startup operator according to the startup operator, to obtain a data sub-format of output data of the startup operator;
if a next operator of the startup operator exists in the historical operators, using the data sub-format of the output data of the startup operator as a data format, using the next operator as a startup operator, and returning to perform the operation of using the data format as a data sub-format of input data of the startup operator; and
if no next operator of the startup operator exists in the historical operators, using the data sub-format of the input data of the startup operator as the data sub-format of the input data of the operator to be processed.

S203: Obtain attribute information of a processor, and perform compilation processing on the initial model file according to the attribute information and the data sub-format, to obtain a final model file of the processor. In an example, attribute information of the processor is obtained and a final model file for the processor is obtained based on compiling the initial model file according to both the attribute information and the data sub-format.

The processor may be a final execution unit for information processing and program running, and may include at least one of a central processing unit (CPU), a graphics processing unit (GPU), or a neural network processing unit (NPU).

The attribute information of the processor may be information for describing a characteristic of the processor. For example, the attribute information of the processor may be an instruction set supported by the processor, an operator type supported by the processor, a type of the processor, or the like. Different processors have different attribute information. For example, different processors support different instruction sets, processors produced by some manufacturers support an x86/x64 instruction set, and processors produced by some manufacturers support an arm instruction set. Therefore, in this embodiment of this disclosure, compilation processing is performed on the initial model file according to the attribute information of the processor, so that a compiled final model file is a file supported by the processor.

The compilation processing may refer to a process of generating processor-executable code from a given neural network model. In this embodiment of this disclosure, in the process of generating the processor-executable code from the neural network model, the compilation processing is mainly converting the neural network model and the data sub-formats of the input data of the operators together into the processor-executable code. In this case, a file formed by the obtained executable code may be referred to as a final model file.

Compilation processing is performed on the initial model file according to the data sub-format, so that the compiled final model file includes the data sub-format, that is, the compiled final model file may include not only the operators but also the data sub-formats of the operators. Therefore, compilation processing is performed on the initial model file according to the attribute information and the data sub-format, to obtain the final model file of the processor, so that the final model file is a file that is supported by the processor and that includes the data sub-format. In this way, when the final model file is run by the processor, the data to be processed with the data format may be processed by using the final model file. Further, the data to be processed with the data format is processed by using the neural network model. Since the data format may be any data format, in this embodiment of this disclosure, data to be processed with a plurality of data formats may be inputted into the processor, thereby improving the flexibility of processing the data to be processed by using the neural network model run by the processor.

In addition, in this embodiment of this disclosure, mapping processing is performed on the data format according to the operator, to obtain the data sub-format of the input data of the operator, and then compilation processing is performed on the initial model file according to the attribute information and the data sub-format, to obtain the final model file matching the processor, so that there is no need to set the data sub-format according to the attribute information of the processor. In this way, the data sub-format can be determined according to this embodiment of this disclosure regardless of which processor is used. Therefore, in this embodiment of this disclosure, the method of performing mapping processing on the data format according to the operator, to obtain a data sub-format of input data of the operator, and performing compilation processing on the initial model file according to the attribute information and the data sub-format, to obtain a final model file of the processor has universality.

When the electronic device includes a plurality of processors, after compilation processing is performed on the initial model file according to the attribute information and the data sub-format, a final model file of each processor may be obtained, where an operator included in the final model file is an operator supported by the processor.

For example, the initial model file includes operator op1 and operator op2, the processor includes a central processing unit and a neural network processing unit, the central processing unit supports operator op1, and the neural network processing unit supports operator op2. Therefore, a final model file matching the central processing unit may include operator op1, and a final model file matching the neural network processing unit may include operator op2.

In some embodiments, a plurality of processors are provided, and the performing compilation processing on the initial model file according to the attribute information and the data sub-format, to obtain a final model file of the processor includes:
obtaining an original computation graph, where the original computation graph includes a node, and the node represents the operator;
partitioning the original computation graph according to the attribute information, to obtain a subgraph matching each processor; and
performing compilation processing on the initial model file according to the attribute information, the data sub-format, and the subgraph, to obtain a final model file of each processor.

In this embodiment of this disclosure, in the initial model file, the operator exists in a form of an original computation graph. The original computation graph is a data structure that includes a node and an edge. The node represents an operator, and the edge represents a flow direction of data of the operator. The subgraph may be a part of the original computation graph, the subgraph may include at least one operator, and each operator included in the subgraph is an operator matching the processor.

Since different processors support different operators, and an operator that is not supported by a processor cannot run on the processor, in this embodiment of this disclosure, a plurality of processors are included. Then, the original computation graph is partitioned according to the attribute information of each processor, to obtain a subgraph matching each processor, that is, obtain a subgraph supported by each processor. Then, compilation processing is performed on the initial model file according to the attribute information, the data sub-format, and the subgraph, to obtain the final model file matching each processor. An entire computation process can be quickly determined based on the original computation graph, to quickly determine operators assigned to different processors, thereby improving the efficiency of determining the final model file.

For example, the original computation graph may be operator op1→operator op2 →operator op3, operator op1 is an operator supported by the central processing unit, and operator op2 and operator op3 are operators supported by the neural network processing unit. Therefore, the original computation graph is partitioned, to obtain that a subgraph matching the neural network processing unit is operator op2→operator op3, and a subgraph matching the central processing unit is operator op1.

In some other embodiments, to improve the speed at which the processor subsequently runs the final model file, a process of partitioning the original computation graph according to the attribute information, to obtain a subgraph matching each processor may be:
determining a startup operator in the original computation graph, and starting traversing from the startup operator according to the attribute information;
marking the startup operator if the startup operator is an operator matching the attribute information, using a next operator of the startup operator as a startup operator, and returning to perform the operation of starting traversing from the startup operator according to the attribute information; or
extracting, if the startup operator is an operator not matching the attribute information, a marked startup operator from the original computation graph, to obtain a subgraph matching the attribute information, using the next operator of the startup operator as a startup operator, and returning to perform the operation of starting traversing from the startup operator according to the attribute information; and
using the subgraph matching the attribute information as the subgraph matching each processor.

For example, the original computation graph is operator op1→operator op2→operator op3→operator op4→operator op5. Operator op3 is an operator supported by the central processing unit, operator op1, operator op2, operator op4, and operator op5 are operators supported by the neural network processing unit, and the startup operator in the original computation graph is operator op1.

Traversing is started from operator op1. Since operator op1 is an operator supported by the neural network processing unit, operator op 1 is marked. A next operator of operator op1 is operator op2. Since operator op2 is an operator supported by the neural network processing unit, operator op2 is marked. A next operator of operator op2 is operator op3. Since operator op3 is not an operator supported by the neural network processing unit, the marked operator op1 and the marked operator op2 are extracted, to obtain that a subgraph matching the neural network processing unit is operator op1→operator op2.

Since a next operator “operator op4” of operator op3 exists, traversing is started from operator op4. Since operator op4 is an operator supported by the neural network processing unit, operator op4 is marked. A next operator of operator op4 is operator op5. Since operator op5 is an operator supported by the neural network processing unit, operator op5 is marked. Since no next operator of operator op5 exists, the marked operator op4 and the marked operator op5 are extracted, to obtain that a subgraph matching the neural network processing unit is operator op4 →operator op5.

In this case, two final model files matching the neural network processing unit may be included. One final model file matching the neural network processing unit includes a subgraph “operator op1→operator op2”, and the other final model file matching the neural network processing unit includes a subgraph “operator op4→operator op5”.

In this embodiment of this disclosure, a startup operator in the original computation graph is determined, and traversing is started from the startup operator according to the attribute information; the startup operator is marked if the startup operator is an operator matching the attribute information, a next operator of the startup operator is used as a startup operator, and the operation of starting traversing from the startup operator according to the attribute information is returned to be performed; if the startup operator is an operator not matching the attribute information, a marked startup operator is extracted from the original computation graph, to obtain a subgraph matching the attribute information, the next operator of the startup operator is used as a startup operator, and the operation of starting traversing from the startup operator according to the attribute information is returned to be performed; and the subgraph matching the attribute information is used as the subgraph matching each processor, so that a plurality of operators matching the processor and having edges can be partitioned into the same subgraph, and the plurality of operators matching the processor and having edges can be stored in the same final model file. In this way, when the final model file is run by the processor subsequently, the number of invokes to the processor can be reduced, and the speed at which the processor runs the final model file can be increased.

In some other embodiments, when the data format is a data shape, a process of performing compilation processing on the model file according to the attribute information, the data sub-format, and the subgraph, to obtain a final model file of each processor may be:
determining an initial data type of input data of the subgraph according to the original computation graph;
determining a final data type of the input data of the subgraph according to the attribute information; and
performing compilation processing on the initial model file according to the attribute information, the data sub-format, the initial data type, and the final data type, to obtain the final model file of each processor.

The initial data type may be a preset data type, and the final data type may be a data type supported by the processor. Therefore, to obtain a final model file supported by the processor, compilation processing may be performed on the initial model file according to the attribute information, the data sub-format, the initial data type, and the final data type, to obtain the final model file of each processor.

A process of performing compilation processing on the initial model file according to the attribute information, the data sub-format, the initial data type, and the final data type, to obtain the final model file matching each processor may be:
obtaining a data type conversion operator if the initial data type is different from the final data type;
adjusting the subgraph according to the data type conversion operator, to obtain a first adjusted subgraph; and
performing compilation processing on the initial model file according to the attribute information, the data sub-format, and the first adjusted subgraph, to obtain the final model file matching each processor.

If the initial data type is different from the final data type, the final data type needs to be converted into the initial data type. Therefore, the data type conversion operator may be added to the subgraph, to convert the data type of the input data of the subgraph into the initial data type, so that the final model file can be subsequently run by the processor.

If the initial data type is the same as the final data type, there is no need to convert the final data type, and compilation processing may be directly performed on the initial model file according to the attribute information, the data sub-format, and the subgraph, to obtain the final model file matching the processor.

For example, the processor is CoreML, and an initial data type of input data of the CoreML is Int32. If a final data type of input data of the original computation graph is Int64, the data type conversion operator (cast operator) is added to the subgraph, to obtain the first adjusted subgraph.

In the foregoing manner, validity of the subgraph is checked, so that in a case that the validity of the subgraph does not satisfy a requirement, the subgraph is adjusted. In this way, a valid subgraph may be used to obtain the final model file, thereby ensuring the correctness of the final model file.

In some other embodiments, when the data format is a data shape, the process of performing compilation processing on the initial model file according to the attribute information, the data sub-format, and the subgraph, to obtain a final model file matching each processor may alternatively be:
determining a first initial data type of output data of the subgraph according to the original computation graph;
determining a first final data type of the output data of the subgraph according to the attribute information;
obtaining an output data type conversion operator if the first initial data type is different from the first final data type;
adjusting the subgraph according to the output data type conversion operator, to obtain a third adjusted subgraph; and
performing compilation processing on the initial model file according to the attribute information, the data sub-format, and the third adjusted subgraph, to obtain the final model file matching each processor.

If the first initial data type is different from the first final data type, the first final data type needs to be converted into the first initial data type. Therefore, the output data type conversion operator may be added to the subgraph, to convert the data type of the output data of the subgraph into the first initial data type, so that the data type of the output data when the final model file is subsequently run by the processor meets a requirement of a user.

If the first initial data type is the same as the first final data type, there is no need to convert the first final data type. In this way, compilation processing may be directly performed on the model file according to the attribute information, the data sub-format, and the subgraph, to obtain the final model file matching the processor.

For example, the processor is CoreML, and a first initial data type of output data of the CoreML is Float32. If a first final data type of output data of the original computation graph is Int8, the output data type conversion operator is added to the subgraph, to obtain the third adjusted subgraph.

The terminal may alternatively obtain the initial data type, the final data type, the first initial data type, and the first final data type simultaneously, and then adjust the subgraph according to the initial data type, the final data type, the first initial data type, and the first final data type simultaneously, to obtain a fourth adjusted subgraph.

For example, the processor is CoreML, an initial data type of input data of the CoreML is Int32, and a first initial data type of output data of the CoreML is Float32. If a final data type of input data of the original computation graph is Int64, and a first final data type of output data of the original computation graph is Int8, the data type conversion operator and the output data type conversion operator are added to the subgraph, to obtain the fourth adjusted subgraph.

In some other embodiments, the performing compilation processing on the initial model file according to the attribute information, the data sub-format, and the subgraph, to obtain a final model file matching each processor includes:
determining a type of an operator in the subgraph;
adjusting the operator in the subgraph if the type of the operator in the subgraph is a preset type, to obtain a second adjusted subgraph; and
performing compilation processing on the initial model file according to the attribute information, the data sub-format, and the second adjusted subgraph, to obtain the final model file matching each processor.

Since some operations may be implemented through different operators, and the processor runs different operators at different speeds, a preset type of an operator may be preset. If a type of an operator in the subgraph is a preset type, the operator in the subgraph is adjusted, to obtain a second adjusted subgraph, and then, compilation processing is performed on the initial model file according to the attribute information, the data sub-format, and the second adjusted subgraph, to obtain the final model file matching each processor, so that the processor quickly runs the operator in the final model file matching the processor.

For example, an addition operator in the subgraph may be converted into a subtraction operator, and an addition operation is implemented through the subtraction operator; a division operator in the subgraph is converted into a multiplication operator, and a division operation is implemented through the multiplication operator; and a convolution operator and the addition operator in the subgraph may be fused into one operator.

S204: Process, when data to be processed is inputted into the neural network model, the data to be processed by the processor by running the final model file, to obtain a processing result of the data to be processed. In an example, a processing result is obtained based on running the final model file, by the processor, with data to be processed by the neural network model.

The type of the data to be processed may be selected according to an actual situation. For example, the data to be processed may be an image to be processed. For another example, the data to be processed may be audio to be processed. This is not limited in the embodiments of this disclosure.

The type of processing on the data to be processed may be selected according to an actual situation. For example, classification may be performed on the data to be processed. For another example, text extraction may be performed on the data to be processed. This is not limited in the embodiments of this disclosure.

The terminal may immediately run the final model file by the processor after obtaining the final model file, or the terminal may run the final model file by the processor after obtaining a running instruction.

If the terminal includes a plurality of processors, that is, there are a plurality of final model files matching the processors, the terminal may invoke each processor in an execution order of an operator in each final model file, to run each final model file.

For example, the final model file includes a final model file f1 and a final model file f2, an execution order of an operator in the final model file f1 precedes an execution order of an operator in the final model file f2, the final model file f1 is a final model file matching the central processing unit, and the final model file f2 is a final model file matching the neural network processing unit. Therefore, after obtaining data to be processed, the terminal first invokes the central processing unit to run the final model file f1 to process the data to be processed, to obtain candidate data, and then invokes the neural network processing unit to run the final model file f2 to process the candidate data, to obtain a processing result of the data to be processed. In this way, the data to be processed is processed by using the neural network model.

In some embodiments, the processing the data to be processed of the neural network model by the processor by running the final model file, to obtain a processing result of the data to be processed includes:
determining a data format of the data to be processed of the neural network model;
adjusting the data format of the data to be processed if the data format of the data to be processed does not match the data sub-format in the final model file, to obtain adjusted data to be processed; and
processing the adjusted data to be processed by the processor by running the final model file, to obtain the processing result of the data to be processed.

That the data format of the data to be processed does not match the data sub-format in the final model file may mean that the data format of the data to be processed is different from the data sub-format of the startup operator in the final model file.

For example, if the final model file includes operator op1→operator op2→operator op3, that the data format of the data to be processed does not match the data sub-format in the final model file may mean that the data format of the data to be processed is different from a data sub-format of operator op1.

The terminal may obtain the data sub-format from the final model file. Alternatively, after obtaining the data sub-format, the terminal may store an identifier and the data sub-format of each operator into a format storage unit in association, and then obtain, from the format storage unit, the data sub-format corresponding to the operator in the final model file.

In this embodiment of this disclosure, before the data to be processed is processed in the final model file, the data format of the data to be processed is first checked, and if the data format of the data to be processed does not match the data sub-format in the final model file, the data format of the data to be processed is corrected, to obtain adjusted data to be processed. Finally, the adjusted data to be processed is processed by the processor by running the final model file, to process the adjusted data to be processed by using the neural network model, to obtain the processing result of the data to be processed.

At a final model file execution stage, the data format of the data to be processed is checked. In this way, in a case that it is detected that the data format of the data to be processed is invalid, the data format of the data to be processed is corrected, thereby ensuring successful execution of processing on the data to be processed, to obtain an accurate processing result.

In some other embodiments, the processing the data to be processed of the neural network model by the processor by running the final model file, to obtain a processing result of the data to be processed includes:
processing the data to be processed of the neural network model by the processor by running the final model file, to obtain a candidate processing result of the data to be processed;
determining an output data format of the candidate processing result; and
adjusting the output data format of the candidate processing result according to the final model file, to obtain the processing result of the data to be processed.

In this embodiment of this disclosure, when mapping processing is performed on the data format according to the operator, the data sub-format of the input data and the data sub-format of the output data of the operator may be obtained simultaneously. That is, the final model file may include both the data sub-format of the input data and the data sub-format of the output data of each operator. Then, after obtaining the candidate processing result, the terminal may determine whether the output data format of the candidate processing result is the same as the data sub-format of the output data of the operator in the final model file, and if the output data format of the candidate processing result is different from the data sub-format of the output data of the operator in the final model file, adjust the output data format of the candidate processing result into the data sub-format of the output data of the operator in the final model file, to obtain the processing result, thereby improving the accuracy of the processing result.

In the embodiments of this disclosure, the data format of the input data of the neural network model is obtained, and the initial model file of the neural network model is obtained, the initial model file including the operator of the neural network model; then mapping processing is performed on the data format according to the operator, to obtain the data sub-format of the input data of the operator; and attribute information of the processor is obtained, and compilation processing is performed on the initial model file according to the attribute information and the data sub-format, to obtain the final model file matching the processor. In this way, the final model file includes the data sub-format and the final model file is a file supported by the processor, so that when the data format of the data to be processed of the neural network model is the data format of the input data of the neural network model, the data to be processed of the neural network model may be processed by the processor by running the final model file, to obtain the processing result of the data to be processed. Since the data format of the input data of the neural network model may be any data format, in the embodiments of this disclosure, the data to be processed with a plurality of data formats may be inputted into the processor, thereby improving the flexibility of processing the data to be processed by using the neural network model run by the processor.

According to the method described in the foregoing embodiment, the following further provides detailed descriptions by using an example.

In this embodiment, an example in which the data format is a data shape, the data sub-format is a data sub-shape, the format mapping scheme is a shape mapping scheme, the data to be processed is an image to be processed, and data processing is text extraction is used for description. This embodiment may be implemented by an inference engine. The inference engine is a system component that applies logical rules to a knowledge base to infer new information.

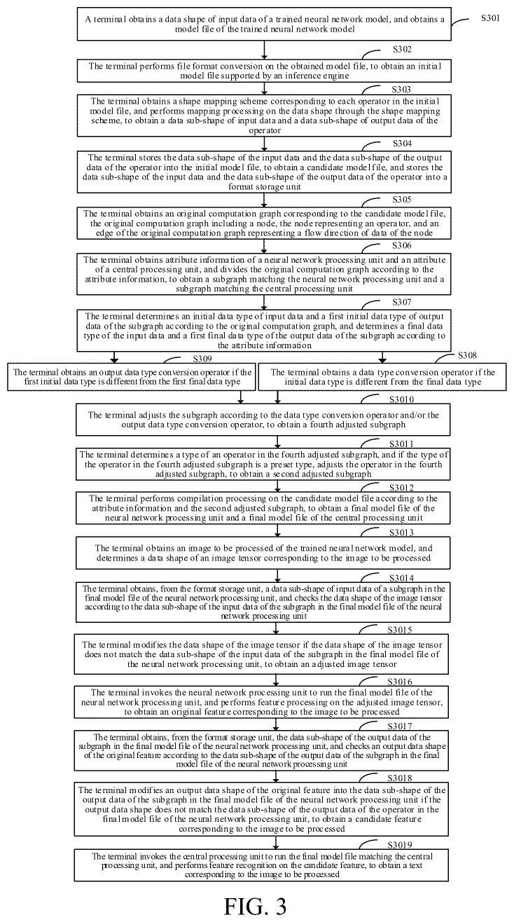

FIG. 3 is a schematic flowchart of a data processing method according to an embodiment of this disclosure. A procedure of the data processing method may include:

S301: A terminal obtains a data shape of input data of a trained neural network model, and obtains a model file of the trained neural network model.

The model file of the trained neural network model includes an operator of the trained neural network model. A file format of the model file of the trained neural network model may be a generic file. For example, the model file of the trained neural network model may be an open neural network exchange (ONNX) model file or an NCNN model file.

S302: The terminal performs file format conversion on the obtained model file, to obtain an initial model file supported by an inference engine.

Since the inference engine has its own recognizable file format, after obtaining the model file of the trained neural network model, the terminal may perform file format conversion on the model file of the trained neural network model, to obtain the initial model file supported by the inference engine.

For example, when the inference engine is a self-developed inference engine and the model file of the trained neural network model is an ONNX model file, the ONNX model file may be converted into an extended network (XNet) model file.

S303: The terminal obtains a shape mapping scheme corresponding to each operator in the initial model file, and performs mapping processing on the data shape through the shape mapping scheme, to obtain a data sub-shape of input data and a data sub-shape of output data of the operator.

S304: The terminal stores the data sub-shape of the input data and the data sub-shape of the output data of the operator into the initial model file, to obtain a candidate model file, and stores the data sub-shape of the input data and the data sub-shape of the output data of the operator into a format storage unit.

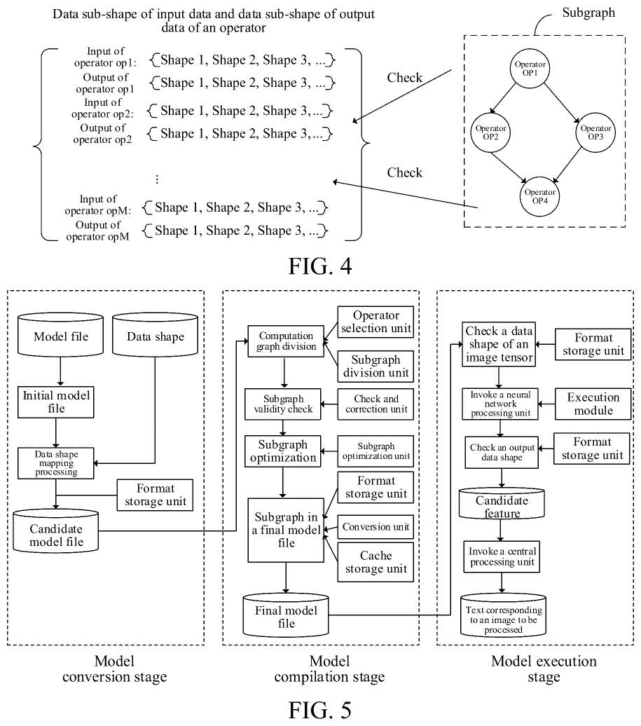

For example, the data sub-shape of the input data and the data sub-shape of the output data of the operator in the format storage unit may be shown in FIGS. 4.

S301 to S304 may be referred to as a model conversion stage, for example, as shown in FIG. 5. The model conversion stage refers to converting an initial model file in a generic file format into a model file in a file format automatically defined by the inference engine.

There may be at least one data shape, and after the data shape is mapped, a data sub-shape of input data and a data sub-shape of output data of the operator for each data shape may be obtained. In other words, in this case, the candidate model file and the format storage unit may include data sub-shapes of input data and data sub-shapes of output data of the operator for all data shapes.

S305: The terminal obtains an original computation graph corresponding to the candidate model file, the original computation graph including a node, the node representing an operator, and an edge of the original computation graph representing a flow direction of data of the node.

S306: The terminal obtains attribute information of a neural network processing unit and an attribute of a central processing unit, and partitions the original computation graph according to the attribute information, to obtain a subgraph matching the neural network processing unit and a subgraph matching the central processing unit.

This operation may be referred to as a computation graph division operation. The computation graph division operation may be performed by a subgraph division unit and an operator selection unit in the inference engine. The subgraph division unit is a generic unit, and may be configured to accelerate subgraph division of hardware. Based on the operator selection unit, a subgraph is selected. All operators in the subgraph are operators selected by the operator selection unit, and there is no operator that is not selected by the operator selection unit on a path between every two operators in the subgraph.

The operator selection unit is configured to configure different neural network processing units, different neural network processing units support different operators, and the operator selection unit is configured to select an operator that is implemented in the neural network processing unit and has good performance.

S307: The terminal determines an initial data type of input data and a first initial data type of output data of the subgraph according to the original computation graph, and determines a final data type of the input data and a first final data type of the output data of the subgraph according to the attribute information.

S308: The terminal obtains a data type conversion operator if the initial data type is different from the final data type.

S309: The terminal obtains an output data type conversion operator if the first initial data type is different from the first final data type.

S3010: The terminal adjusts the subgraph according to the data type conversion operator and/or the output data type conversion operator, to obtain a fourth adjusted subgraph.

The subgraphs in S307 to S3010 may be a subgraph matching the neural network processing unit and a subgraph matching the central processing unit. S307 to S3010 may be referred to as subgraph validity check operations, and may be performed by a check and correction unit. In other words, the check and correction unit is configured to check whether the data type of the input data of the original computation graph is the same as the data type of the input data of the subgraph, and is configured to check whether the data type of the output data of the original computation graph is the same as the data type of the output data of the subgraph.

S3011: The terminal determines a type of an operator in the fourth adjusted subgraph, and if the type of the operator in the fourth adjusted subgraph is a preset type, adjusts the operator in the fourth adjusted subgraph, to obtain a second adjusted subgraph.

S3012: The terminal performs compilation processing on the candidate model file according to the attribute information and the second adjusted subgraph, to obtain a final model file of the neural network processing unit and a final model file of the central processing unit.

S3012 may be performed by a conversion unit, that is, an operator definition in the candidate model file is converted into an operator definition of the neural network processing unit and an operator definition of the central processing unit.

S3011 and S3012 may be referred to as subgraph optimization operations, and may be performed by a subgraph optimization unit. The subgraph optimization unit is configured to optimize the subgraph.

S305 to S3012 may be referred to as a model compilation stage, for example, as shown in FIG. 5. The model compilation stage is performed once before the trained neural network model is executed, and may be implemented by selecting a specific processor.

In a possible implementation, at the model compilation stage, an intermediate expression of the neural network processing unit may further be stored by a Cache storage unit. For example, when the neural network processing unit is a CoreML processor, a mlmodelc file may be stored by the Cache storage unit, and when the neural network processing unit is a processor produced by a manufacturer, an om file may be stored by the Cache storage unit.

S3013: The terminal obtains an image to be processed of the trained neural network model, and determines a data shape of an image tensor corresponding to the image to be processed.

S3014: The terminal obtains, from the format storage unit, the data sub-shape of the input data of the subgraph in the final model file of the neural network processing unit, and checks the data shape of the image tensor according to the data sub-shape of the input data of the subgraph in the final model file of the neural network processing unit.

S3015: The terminal modifies the data shape of the image tensor if the data shape of the image tensor does not match the data sub-shape of the input data of the subgraph in the final model file of the neural network processing unit, to obtain an adjusted image tensor.

For example, the subgraph in the final model file of the neural network processing unit may be shown in FIG. 4. The subgraph includes operator op1, operator op2, operator op3, and operator op4. Operator op1 is an input node, that is, operator op1 is a startup operator. The data shape of the image tensor is checked according to a data sub-shape of input data of operator op1.

S3016: The terminal invokes the neural network processing unit to run the final model file of the neural network processing unit, and performs feature processing on the adjusted image tensor, to obtain an original feature corresponding to the image to be processed.

S3017: The terminal obtains, from the format storage unit, the data sub-shape of the output data of the subgraph in the final model file of the neural network processing unit, and checks an output data shape of the original feature according to the data sub-shape of the output data of the subgraph in the final model file of the neural network processing unit.

S3018: The terminal modifies an output data shape of the original feature into the data sub-shape of the output data of the subgraph in the final model file of the neural network processing unit if the output data shape does not match the data sub-shape of the output data of the operator in the final model file of the neural network processing unit, to obtain a candidate feature corresponding to the image to be processed.

For example, the subgraph in the final model file of the neural network processing unit may be shown in FIG. 4. The subgraph includes operator op1, operator op2, operator op3, and operator op4. Operator op4 is an output node, that is, operator op4 is the last operator. The output data shape of the original feature is checked according to a data sub-shape of output data of operator op4.

In this embodiment of this disclosure, the output data shape of the output data of the neural network processing unit is checked, to avoid an error in the data shape of the output data in a case that there are a plurality of data shapes.

S3019: The terminal invokes the central processing unit to run the final model file of the central processing unit, and performs feature recognition on the candidate feature, to obtain a text corresponding to the image to be processed.

When invoking the central processing unit to run the final model file of the central processing unit, the terminal may also check a data shape of the candidate feature and a data shape of the text corresponding to the image to be processed. For details, reference may be made to the process of checking the data shape of the image tensor and the output data shape when invoking the neural network processing unit to run the final model file of the neural network processing unit. Details are not described herein again in the embodiments of this disclosure.

S3013 to S3019 may be performed by a processing module. The processing module may also be referred to as an execution module. An interface provided by a manufacturer of the neural network processing unit is invoked by the execution module, to invoke the neural network processing unit.

S3013 to S3019 may be referred to as a model execution stage. That is, a process of deploying the trained neural network model to the neural network processing unit and the central processing unit in this embodiment may include a model conversion stage, a model compilation stage, and a model execution stage.

Compared with the central processing unit, the neural network processing unit has higher computing power, and is more focused on high-density computation. For example, peak theoretical computing power (the peak theoretical computation power refers to the maximum number of floating-point/fixed-point computations that can be completed by hardware within a period of time) of the neural network processing unit reaches 11T FLOP/s (FLOP/s represents the number of floating-point computations that can be completed per second), and the peak theoretical computation power of a large core of the central processing unit is only 96 GFLOP/s.

Therefore, in this embodiment of this disclosure, the trained neural network model is deployed by the neural network processing unit, so that the speed at which the text of the image to be processed is extracted by the trained neural network model can be improved.

In addition, the central processing unit in this embodiment of this disclosure may be a self-developed high-performance processor. Deploying the trained neural network model on the self-developed high-performance processor can also improve the speed at which the text of the image to be processed is extracted by the trained neural network model.

Compared with the graphics processing unit, the neural network processing unit has lower power consumption. Therefore, in this embodiment of this disclosure, the trained neural network model is deployed by the neural network processing unit, so that the power consumption when the text of the image to be processed is extracted by the trained neural network model can be reduced.

Therefore, this embodiment of this disclosure provides a framework for using a neural network processing unit. The framework is implemented in combination with a self-developed high-performance operator, thereby greatly improving the text extraction speed of the trained neural network models deployed on the neural network processing unit and the central processing unit.

For a specific implementation method and beneficial effects of this embodiment, reference may be made to the foregoing data processing method embodiments, and details are not described herein again in this embodiment.

To better implement the data processing method provided in the embodiments of this disclosure, an embodiment of this disclosure further provides an apparatus based on the data processing method. Terms in the apparatus have meanings the same as those in the data processing method. For specific implementation details, reference may be made to the description in the method embodiments.

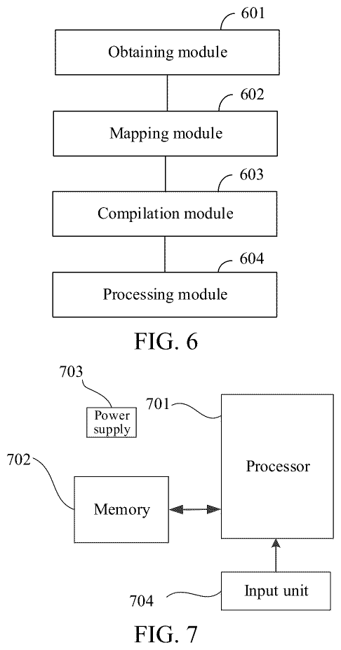

For example, as shown in FIG. 6, the data processing apparatus may include:
an obtaining module 601, configured to obtain a data format of input data of a neural network model, and obtain an initial model file of the neural network model, the initial model file including an operator of the neural network model;
a mapping module 602, configured to perform mapping processing on the data format according to the operator, to obtain a data sub-format of input data of the operator;
a compilation module 603, configured to obtain attribute information of the processor, and perform compilation processing on the initial model file according to the attribute information and the data sub-format, to obtain a final model file of the processor; and
a processing module 604, configured to process, when data to be processed is inputted into the neural network model, the data to be processed by the processor by running the final model file, to obtain a processing result of the data to be processed.

In a possible implementation, the mapping module 602 is specifically configured to:
obtain a format mapping scheme corresponding to the operator; and
perform mapping processing on the data format through the format mapping scheme, to obtain the data sub-format of the input data of the operator.

In a possible implementation, the mapping module 602 is specifically configured to:
select a startup operator from operators, and use the data format as a data sub-format of input data of the startup operator;
perform mapping processing on the data sub-format of the input data of the startup operator according to the startup operator, to obtain a data sub-format of output data of the startup operator; and
if a next operator of the startup operator exists in the operators, use the data sub-format of the output data of the startup operator as a data format, use the next operator as a startup operator, and return to perform the operation of using the data format as a data sub-format of input data of the startup operator; or
if no next operator of the startup operator exists in the operators, determine the data sub-format of the input data of the operator according to the data sub-format of the input data of the startup operator.

In a possible implementation, the mapping module 602 is specifically configured to:
select an operator to be processed from the operators, and determine a historical operator preceding the operator to be processed in the neural network model;
perform mapping processing on the data format according to the historical operator, to obtain a data sub-format of input data of the operator to be processed; and
determine the data sub-format of the input data of the operator according to the data sub-format of the input data of the operator to be processed.

In a possible implementation, the mapping module 602 is specifically configured to:
determine a conversion model parameter according to a model parameter of the historical operator; and
perform mapping processing on the data format according to the conversion model parameter, to obtain the data sub-format of the input data of the operator to be processed.

In a possible implementation, a plurality of processors are provided. Correspondingly, the compilation module 603 is specifically configured to:
obtain an original computation graph, where the original computation graph includes a node, and the node represents the operator;
partition the original computation graph according to the attribute information, to obtain a subgraph matching each processor; and
perform compilation processing on the initial model file according to the attribute information, the data sub-format, and the subgraph, to obtain a final model file of each processor.

In a possible implementation, the compilation module 603 is specifically configured to:
determine an initial data type of input data of the subgraph according to the original computation graph;
determine a final data type of the input data of the subgraph according to the attribute information; and
perform compilation processing on the initial model file according to the attribute information, the data sub-format, the initial data type, and the final data type, to obtain the final model file of each processor.

In a possible implementation, the compilation module 603 is specifically configured to:
obtain a data type conversion operator if the initial data type is different from the final data type;
adjust the subgraph according to the data type conversion operator, to obtain a first adjusted subgraph; and
perform compilation processing on the initial model file according to the attribute information, the data sub-format, and the first adjusted subgraph, to obtain the final model file of each processor.

In a possible implementation, the compilation module 603 is specifically configured to:
determine a type of an operator in the subgraph;
adjust the operator in the subgraph if the type of the operator in the subgraph is a preset type, to obtain a second adjusted subgraph; and
perform compilation processing on the initial model file according to the attribute information, the data sub-format, and the second adjusted subgraph, to obtain the final model file of each processor.

In a possible implementation, the processing module 604 is specifically configured to:
determine a data format of the data to be processed of the neural network model;
adjust the data format of the data to be processed if the data format of the data to be processed does not match the data sub-format in the final model file, to obtain adjusted data to be processed; and
process the adjusted data to be processed by the processor by running the final model file, to obtain the processing result of the data to be processed.

In a possible implementation, the processing module 604 is specifically configured to:
process the data to be processed of the neural network model by the processor by running the final model file, to obtain a candidate processing result of the data to be processed;
determine an output data format of the candidate processing result; and
adjust the output data format of the candidate processing result according to the final model file, to obtain the processing result of the data to be processed.

During specific implementation, the foregoing modules may be implemented as independent entities or may be combined in various manners as a same entity or several entities for implementation. For specific implementations and corresponding beneficial effects of the foregoing modules, reference may be made to the foregoing method embodiments. Details are not provided herein again.

An embodiment of this disclosure further provides an electronic device. The electronic device may be a server, a terminal, or the like. As shown in FIG. 7, FIG. 7 is a schematic diagram of a structure of an electronic device according to an embodiment of this disclosure.

Specifically, the electronic device may include components such as a processor 701 including one or more processing cores, a memory 702 including one or more computer-readable storage media, a power supply 703, and an input unit 704. A person skilled in the art may understand that the structure of the electronic device shown in FIG. 7 does not constitute a limitation to the electronic device, and the electronic device may include more components or fewer components than those shown in the figure, or some components may be combined, or a different component deployment may be used.

The processor 701 is a control center of the electronic device, which is connected to various parts of the entire electronic device by using various interfaces and lines, and implements various functions and data processing of the electronic device by running or executing a computer program and/or module stored in the memory 702, and invoking data stored in the memory 702. In some embodiments, the processor 701 may include one or more processing cores. Preferably, the processor 701 may integrate an application processor and a modem. The application processor mainly processes an operating system, a user interface, an application program, and the like. The modem mainly processes wireless communication. The modem may alternatively not be integrated into the processor 701.

The memory 702 may be configured to store a computer program and a module. The processor 701 runs the computer program and the module stored in the memory 702, to implement various functional applications and data processing. The memory 702 may mainly include a program storage area and a data storage area. The program storage area may store an operating system, a computer program required by at least one function (such as a sound playback function and an image display function), and the like. The data storage area may store data created according to use of the electronic device, and the like. In addition, the memory 702 may include a high-speed random access memory, and may further include a non-volatile memory, such as at least one disk memory device, a flash memory device, or another volatile solid-state memory device. Correspondingly, the memory 702 may further include a memory controller configured to provide the processor 701 with access to the memory 702.

The electronic device further includes the power supply 703 for supplying power to the components. Preferably, the power supply 703 may be logically connected to the processor 701 by using a power management system, thereby implementing functions such as charging, discharging, and power consumption management by using the power management system. The power supply 703 may further include one or more direct current or alternating current power supplies, a re-charging system, a power failure detection circuit, a power converter or inverter, a battery status indicator, and any other component.

The electronic device may further include the input unit 704. The input unit 704 may be configured to receive entered numeric or character information and generate keyboard, mouse, joystick, optical, or trackball signal inputs related to user settings and function control.

Although not shown in the figure, the electronic device may further include a display unit, and the like. Details are not described herein again. Specifically, in this embodiment, the processor 701 in the electronic device may load, according to the following instructions, executable files corresponding to processes of one or more computer programs into the memory 702. The processor 701 runs the computer programs stored in the memory 702, to implement the data processing method provided in the foregoing embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

For specific implementations of the foregoing operations and corresponding beneficial effects, reference may be made to the foregoing detailed descriptions of the data processing method. Details are not described herein again.

A person of ordinary skill in the art may understand that all or some of the operations of the methods in the foregoing embodiments may be implemented by a computer program, or implemented by a computer program controlling relevant hardware. The computer program may be stored in a computer-readable storage medium, and loaded and executed by a processor.

Therefore, an embodiment of this disclosure provides a computer-readable storage medium, such as a non-transitory computer-readable storage medium, having a computer program stored therein. The computer program can be loaded by a processor to perform operations in any data processing method provided in the embodiments of this disclosure.

For specific implementations of the foregoing operations and corresponding beneficial effects, reference may be made to the foregoing embodiments. Details are not described herein again.

The computer-readable storage medium may include: a read only memory (ROM), a random access memory (RAM), a magnetic disk, an optical disc, or the like.

Since the computer program stored in the computer-readable storage medium may implement the operations of any data processing method provided in the embodiments of this disclosure, the computer program can implement beneficial effects that may be implemented by any data processing method provided in the embodiments of this disclosure. For details, refer to the foregoing embodiments. Details are not described herein again.

According to an aspect of this disclosure, a computer program product is provided. The computer program product includes a computer program, and the computer program is stored in a computer-readable storage medium. A processor of a computer device reads the computer program from the computer-readable storage medium, and the processor executes the computer program to cause the computer device to perform the foregoing data processing method.

The data processing method and apparatus, the device, the storage medium, and the program product provided in the embodiments of this disclosure are described above in detail. Although the principles and implementations of this disclosure are described by using specific examples in this specification, the foregoing descriptions of the embodiments are merely intended to help understand the method and core idea of this disclosure. Moreover, a person skilled in the art may make modifications to the specific implementations and disclosure range according to the idea of this disclosure. In conclusion, the content of the specification is not to be construed as a limitation to this disclosure.

What is claimed is:

1. A data processing method, comprising:
obtaining an indication of a data format of input data of a neural network model;
obtaining an initial model file for the neural network model, the initial model file indicating an operator of the neural network model;
obtaining, by processing circuitry, a data sub-format of input data of the operator based on both the data format and the operator;
obtaining attribute information of the processing circuitry;
obtaining a final model file for the processing circuitry based on compiling the initial model file according to both the attribute information and the data sub-format; and
obtaining a processing result based on running the final model file, by the processing circuitry, with data to be processed by the neural network model.

2. The data processing method according to claim 1, wherein the obtaining the data sub-format comprises:
obtaining a format mapping scheme corresponding to the operator; and
obtaining the data sub-format of the input data of the operator based on mapping the data format to the data sub-format through the format mapping scheme.

3. The data processing method according to claim 1, wherein the obtaining the data sub-format comprises:
selecting a startup operator from operators;
obtaining a data sub-format of output data of the startup operator based on both the startup operator and the data format as a data sub-format of input data of the startup operator;
based on a next operator of the startup operator existing in the operators, with the data sub-format of the output data of the startup operator as the data format and the next operator as the startup operator, returning to obtaining the data sub-format of output data of the startup operator; and
based on no next operator of the startup operator existing in the operators, determining the data sub-format of the input data of the operator according to the data sub-format of the input data of the startup operator.

4. The data processing method according to claim 2, wherein the obtaining the data sub-format of input data of the operator comprises:
selecting a particular operator from the operators;
determining a historical operator preceding the particular operator;
obtaining a data sub-format of input data of the particular operator based on both the data format and the historical operator; and
determining the data sub-format of the input data of the operator according to the data sub-format of the input data of the particular operator.

5. The data processing method according to claim 4, wherein the obtaining the data sub-format of the input data of the particular operator comprises:
determining a conversion model parameter according to a model parameter of the historical operator; and
obtaining the data sub-format of the input data of the particular operator based on both the data format and the conversion model parameter.

6. The data processing method according to claim 1, wherein a plurality of processors are provided in the processing circuitry, and obtaining the final model file for the processing circuitry comprises:
obtaining an original computation graph, wherein the original computation graph comprises a node that represents the operator;
partitioning, according to the attribute information, the original computation graph into a subgraph matching each processor; and
obtaining a final model file of each processor based on compiling the initial model file according to the attribute information, the data sub-format, and the subgraph.

7. The data processing method according to claim 6, wherein the obtaining the final model file of each processor comprises:
determining an initial data type of input data of the subgraph according to the original computation graph;
determining a final data type of the input data of the subgraph according to the attribute information; and
obtaining the final model file of each processor based on compiling the initial model file according to the attribute information, the data sub-format, the initial data type, and the final data type.

8. The data processing method according to claim 7, wherein the obtaining the final model file of each processor based on compiling the initial model file according to the attribute information, the data sub-format, the initial data type, and the final data type comprises:
obtaining a data type conversion operator based on the initial data type being different from the final data type;
obtaining a first adjusted subgraph based on adjusting the subgraph according to the data type conversion operator; and
obtaining the final model file of each processor based on compiling the initial model file according to the attribute information, the data sub-format, and the first adjusted subgraph.

9. The data processing method of claim 8, wherein the obtaining the final model file of each processor based on compiling the initial model file according to the attribute information, the data sub-format, and the first adjusted subgraph comprises:
determining a type of an operator in the subgraph;
obtaining a second adjusted subgraph based on adjusting the operator in the subgraph based on the type of the operator in the subgraph being a preset type; and
obtaining the final model file of each processor based on compiling the initial model file according to the attribute information, the data sub-format, and the second adjusted subgraph.

10. The data processing method of claim 1, wherein the obtaining the processing result comprises:
determining a data format of the data to be processed of the neural network model;
obtaining adjusted data to be processed based on adjusting the data format of the data to be processed based on the data format of the data to be processed not matching the data sub-format in the final model file; and
obtaining the processing result based on running the final model file with the adjusted data to be processed.

11. The data processing method according to claim 10, wherein the obtaining the processing result comprises:
obtaining a candidate processing result of the data to be processed based on running the final model file with the data to be processed;
determining an output data format of the candidate processing result; and
obtaining the processing result based on adjusting the output data format of the candidate processing result according to the final model file.

12. A data processing apparatus comprising:
processing circuitry configured to:
obtain an indication of a data format of input data of a neural network model;
obtain an initial model file for the neural network model, the initial model file indicating an operator of the neural network model;
obtain a data sub-format of input data of the operator based on both the data format and the operator;
obtain attribute information of the processing circuitry;
obtain a final model file for the processing circuitry based on compiling the initial model file according to both the attribute information and the data sub-format; and
obtain a processing result based on running the final model file, by the processing circuitry, with data to be processed by the neural network model.

13. The data processing apparatus of claim 12, wherein the obtain the data sub-format comprises:
obtain a format mapping scheme corresponding to the operator; and
obtain the data sub-format of the input data of the operator based on mapping the data format through the format mapping scheme.

14. The data processing apparatus of claim 12, wherein the obtain the data sub-format comprises:
select a startup operator from operators;
obtain a data sub-format of output data of the startup operator based on both the startup operator and the data format as a data sub-format of input data of the startup operator;
based on a next operator of the startup operator existing in the operators, with the data sub-format of the output data of the startup operator as the data format and the next operator as the startup operator, return to obtain the data sub-format of output data of the startup operator; and
based on no next operator of the startup operator existing in the operators, determine the data sub-format of the input data of the operator according to the data sub-format of the input data of the startup operator.

15. The data processing apparatus of claim 13, wherein the obtain the data sub-format of input data of the operator comprises:
select a particular operator from the operators;
determine a historical operator preceding the particular operator;
obtain a data sub-format of input data of the particular operator based on both the data format and the historical operator; and
determine the data sub-format of the input data of the operator according to the data sub-format of the input data of the particular operator.

16. The data processing apparatus of claim 15, wherein the obtain the data sub-format of the input data of the particular operator comprises:
determine a conversion model parameter according to a model parameter of the historical operator; and
obtain the data sub-format of the input data of the particular operator based on both the data format and the conversion model parameter.

17. A non-transitory computer-readable storage medium, storing instructions which when executed by a processor cause the processor to perform:
obtaining an indication of a data format of input data of a neural network model;
obtaining an initial model file for the neural network model, the initial model file indicating an operator of the neural network model;
obtaining, by the processor, a data sub-format of input data of the operator based on both the data format and the operator;
obtaining attribute information of the processor;
obtaining a final model file for the processor based on compiling the initial model file according to both the attribute information and the data sub-format; and
obtaining a processing result based on running the final model file, by the processor, with data to be processed by the neural network model.

18. The non-transitory computer-readable storage medium of claim 17, wherein the obtaining the data sub-format comprises:
obtaining a format mapping scheme corresponding to the operator; and
obtaining the data sub-format of the input data of the operator based on mapping the data format through the format mapping scheme.

19. The non-transitory computer-readable storage medium of claim 17, wherein the obtaining the data sub-format comprises:
selecting a startup operator from operators;
obtaining a data sub-format of output data of the startup operator based on both the startup operator and the data format as a data sub-format of input data of the startup operator;
based on a next operator of the startup operator existing in the operators, with the data sub-format of the output data of the startup operator as the data format and the next operator as the startup operator, returning to obtaining the data sub-format of output data of the startup operator; and
based on no next operator of the startup operator existing in the operators, determining the data sub-format of the input data of the operator according to the data sub-format of the input data of the startup operator.

20. The non-transitory computer-readable storage medium of claim 18, wherein the obtaining the data sub-format of input data of the operator comprises:
selecting a particular operator from the operators;
determining a historical operator preceding the particular operator;
obtaining a data sub-format of input data of the particular operator based on both the data format and the historical operator; and
determining the data sub-format of the input data of the operator according to the data sub-format of the input data of the particular operator.
